(19) United States
(12) Patent Application Publication
(10) Pub. No.: US 2025/0249867 A1
(43) Pub. Date: Aug. 7, 2025

(54) Dual-Mode Landing Gear Adapter with Interchangeable Manual and Powered Drive

(71) Applicant: Steven Dwight Davis, Eastvale, CA (US)

(72) Inventor: Steven Dwight Davis, Eastvale, CA (US)

(21) Appl. No.: 19/187,491

(22) Filed: Apr. 23, 2025

Related U.S. Application Data
(63) Continuation-in-part of application No. 18/519,710, filed on Nov. 27, 2023.

(51) Int. Cl. B60S 9/04; B25F 3/00

(52) U.S. Cl. CPC B60S 9/04; B25F 3/00

(57) ABSTRACT

A dual-mode landing gear adapter enables rapid interchangeability between manual and powered operation for trailer landing gear extension and retraction. The adapter includes a gear shaft adapter having a first coupling end structured to securely engage the trailer's landing gear gearbox shaft, and an opposite second coupling end with axial slots configured for receiving a two-pin anchor. A manual crank and a drill head attachment each include a corresponding two-pin anchor for secure, selective coupling with the adapter. The drill head attachment further comprises a cylindrical collar structured to securely receive a standard electrically powered drill/driver, secured via a cotter pin or similar fastening device. The invention facilitates quick, secure switching between powered and manual operation without tools, ensuring convenience, safety, and operational flexibility. This adapter system reduces user effort, increases efficiency, and provides robust reliability under varying operational conditions common in commercial trucking and trailer applications.

### CROSS-REFERENCE TO RELATED APPLICATIONS

This application claims benefit to the earlier filing date and right of priority under 35 U.S.C. § 120 to patent application Ser. No. 18/519,710, titled Landing Gear Lowering and Retraction Automation Tool, filed 27 Nov. 2023 by Steven Dwight Davis, the contents of which are herein incorporated by reference under 37 CFR 1.57(b).

### BACKGROUND OF THE INVENTION

### Technical Field

This invention relates generally to a landing gear automation device for trailers. This invention relates more particularly to an apparatus/device for selectively coupling a trailer's landing gear shaft with either a manual hand crank or a powered drill/driver to automate the extension and retraction of the landing gear. This invention relates generally to apparatuses and devices for operating trailer landing gear. This method also can be used with manual crank handles and standard electrically powered drill/drivers. This invention relates more particularly to a gear shaft adapter to securely and interchangeably couple a manual crank or drill/driver to a trailer's landing gear shaft.

The present invention pertains generally to the field of transportation and vehicle support equipment, specifically relating to apparatuses and mechanical adapters configured for the operation and automation of landing gear systems utilized on trailers and similar vehicles. The invention particularly relates to adapters that selectively facilitate both manual and powered operation for raising, lowering, extending, or retracting the landing gear of trailers, enabling ease of use, improved operational efficiency, and increased operator convenience and safety.

More particularly, the invention relates to mechanical coupling devices and adapters classified within transportation equipment and accessories, specifically those intended for selectively connecting rotational input devices-such as manually-operated crank handles or powered rotary drivers to trailer landing gear shafts. The invention involves structural improvements to adapters, enabling rapid interchangeability between manual and power-driven operational modes while maintaining secure mechanical engagement with landing gear drive shafts.

### Background Art

Landing gear assemblies for trailers generally include mechanical components, such as shafts, gearboxes, and manual crank handles, that allow operators to raise or lower the landing gear legs to support or disengage the trailer from a towing vehicle. Traditionally, operation of these landing gear assemblies involves manual rotation of a crank handle, requiring significant physical effort and time, particularly when adjusting heavily loaded trailers or when frequent coupling and uncoupling is necessary.

Various approaches in the prior art have aimed at automating or simplifying the operation of landing gear systems. Such approaches include permanently installed motorized gear systems and pneumatic or hydraulic actuators. However, these permanently installed automated systems typically add complexity, weight, and cost to the trailer and require substantial modifications to existing landing gear assemblies. Moreover, they often depend on additional infrastructure, such as onboard electrical or pneumatic power supplies, increasing maintenance burdens.

Other prior art solutions have incorporated adapters intended for use with portable rotary power tools to operate landing gear. These adapters typically involve connecting a power-driven rotary tool, such as a drill or wrench, to the existing landing gear shaft. However, such adapters often fail to provide secure and reliable coupling, especially under conditions of high torque and repetitive use. Additionally, they do not permit rapid or secure interchangeability between manual and powered operation, requiring tools or complex procedures for attachment and removal.

Furthermore, adapters available in the prior art frequently lack sufficient structural reinforcement, dimensional compatibility, and secure attachment features necessary to ensure reliable and safe operation under varied conditions. The absence of effective securing mechanisms and easy interchangeability between manual and powered modes can compromise safety, cause increased operational downtime, and reduce overall productivity.

In light of the foregoing prior art, there is a need for a landing gear adapter that securely and conveniently enables rapid interchangeability between manual and powered operation modes, to better improve operator convenience, enhance operational safety, and increase efficiency in raising and lowering trailer landing gear.

### BRIEF SUMMARY OF THE INVENTION

The present invention is directed generally to a Dual-Mode Landing Gear Adapter with Interchangeable Manual and Powered Drive. The inventive concept is centered on a gear shaft adapter structured to securely and selectively couple to a trailer landing gear shaft, providing rapid interchangeability between manual crank handles and powered rotary drivers, such as portable electric drills. The adapter significantly simplifies the process of operating landing gear by allowing the user to quickly choose between manual and powered operation modes without requiring specialized tools or complex procedures.

According to a first aspect of the invention, there is provided a Dual-Mode Landing Gear Adapter with Interchangeable Manual and Powered Drive comprising a gear shaft adapter having a first coupling end structured to securely engage with a gearbox shaft of a trailer landing gear, and an opposing second coupling end provided with a set of slots designed to selectively engage a two-pin anchor; and a drill head attachment configured for operable connection to an electrically powered drill or driver, said drill head attachment similarly configured with a two-pin anchor selectively engageable with the slots. Further features of the invention include specific dimensional and material characteristics for enhanced durability and reliability, ergonomic design for operator comfort, and structural adaptations enabling secure attachment and detachment without additional tools or hardware. And, optimally a manual crank configured with a two-pin anchor adapted for selective engagement with the slots.

According to a second aspect of the invention, there is provided a Dual-Mode Landing Gear Adapter with Interchangeable Manual and Powered Drive in the form of a cylindrical drill head attachment for securely receiving and coupling with a portable electrically powered drill/driver. An advantage of this drill head attachment is that it enables quick and secure coupling with commonly available cordless or corded drills, simplifying operational procedures and reducing reliance on proprietary motorized gear assemblies. This cylindrical attachment is advantageously configured to include alignment indicators and securing mechanisms, such as removable cotter pins, providing stable, reliable engagement of the drill/driver during operation.

According to a third aspect of the invention, there is provided a Dual-Mode Landing Gear Adapter with Interchangeable Manual and Powered Drive in the form of an operational method for selectively coupling and operating either a manual crank or a drill-driven attachment. An advantage of this operational method is the simplified and rapid interchangeability between powered and manual operation, offering flexibility and adaptability under various working conditions. This method involves straightforward alignment, insertion, and removal steps, performed quickly and securely without additional tooling or complicated procedures.

According to a further feature of the invention, the first coupling end of the gear shaft adapter may include at least one aperture structured to receive a fastener, enhancing secure attachment to the landing gear gearbox shaft.

According to another feature of the invention, the two-pin anchor is structured with pins positioned diametrically opposite each other, providing balanced torque transfer and secure engagement with the slots of the gear shaft adapter.

According to another feature of the invention, the slots at the second coupling end of the gear shaft adapter extend axially and are open-ended, facilitating quick insertion and removal of the two-pin anchor.

According to another feature of the invention, the gear shaft adapter may be constructed from a hardened metal alloy, providing strength and durability under repeated torque application.

According to another feature of the invention, the manual crank comprises an ergonomic handle opposite the two-pin anchor, enhancing user comfort and ease of manual operation.

According to another feature of the invention, the cylindrical collar may have a length of approximately 9.779 centimeters, ensuring compatibility with standard electrically powered drills and drivers.

According to another feature of the invention, the cylindrical collar may include an internal diameter of at least 2.5 centimeters at the open end, facilitating secure and easy attachment of standard drill/drivers.

According to another feature of the invention, the securing mechanism may comprise a cotter pin extending through aligned openings formed through a sidewall of the cylindrical collar, reliably securing the drill/driver in place.

According to another feature of the invention, the aligned openings may have a diameter between 0.635 centimeters and 1.27 centimeters, sized for effective and secure fastening with a cotter pin.

According to another feature of the invention, the cylindrical collar may further comprise alignment indicators, aiding operators in ensuring correct positioning and engagement of the drill/driver.

According to another feature of the invention, the electrically powered drill/driver used may be cordless and battery-operated, increasing operational convenience and portability.

According to another feature of the invention, coupling the gear shaft adapter to the gearbox shaft may include aligning an indexing feature on the adapter with a corresponding indexing feature on the gearbox shaft, ensuring proper rotational alignment.

According to another feature of the invention, engaging the two-pin anchor within the slots may comprise inserting the two-pin anchor axially into the slots and rotating the anchor to lock it securely in place.

According to another feature of the invention, the drill/driver may be secured to the drill head attachment using a cotter pin inserted through aligned openings, providing reliable and tool-free securing of the power tool.

According to another feature of the invention, rotational speed of the drill/driver may be controlled using a variable-speed trigger control, providing the operator precise operational control.

According to another feature of the invention, removing the crank or drill head attachment may include rotating the attachment to disengage the two-pin anchor from the slots, enabling quick and simple decoupling.

According to another feature of the invention, coupling and decoupling of the crank or drill head attachment may be performed without additional tools, significantly improving operational efficiency and convenience.

Advantages of the present invention include significantly improved convenience for operators through rapid interchangeability of operational modes, improved safety through reliable and secure attachment mechanisms, and increased operational efficiency achieved by seamlessly switching between manual and powered operation as required. Furthermore, the invention offers economic advantages through compatibility with existing drill/drivers, eliminating the need for expensive integrated or permanently installed powered systems, and provides structural simplicity that reduces both manufacturing and maintenance costs.

The invention will now be described, by way of example only, with reference to the accompanying drawings in which:

### BRIEF DESCRIPTION OF THE SEVERAL VIEWS OF THE DRAWINGS

FIG. 1 is a side view of the dual-mode landing gear adapter with interchangeable manual and powered drive according to the invention;

FIG. 2 is a top view of the dual-mode landing gear adapter with interchangeable manual and powered drive according to the invention;

FIG. 3 is a cross section view of the dual-mode landing gear adapter with interchangeable manual and powered drive according to the invention;

FIG. 4 is a perspective view of the dual-mode landing gear adapter with interchangeable manual and powered drive according to the invention;

FIG. 5 is a perspective view of the dual-mode landing gear adapter with interchangeable manual and powered drive attached to a drill according to the invention.

FIG. 6 is a perspective view of the dual-mode landing gear adapter with interchangeable manual and powered drive attached to a drill being used on a landing gear according to the invention.

FIG. 7 is an exploded view of the dual-mode landing gear adapter with interchangeable manual and powered drive according to the invention; and

FIG. 8 is a flowchart of the method of operating a landing gear on a trailer using the dual-mode landing gear adapter with interchangeable manual and powered drive according to the invention.

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise,” or variations thereof such as “comprises” or “comprising,” will be understood to imply the inclusion of a stated element, integer or step, or group of elements integers or steps, but not the exclusion of any other element, integer or step, or group of elements, integers or steps.

Index of Labelled Features in Figures. Features are listed in numeric order by Figure in numeric order.

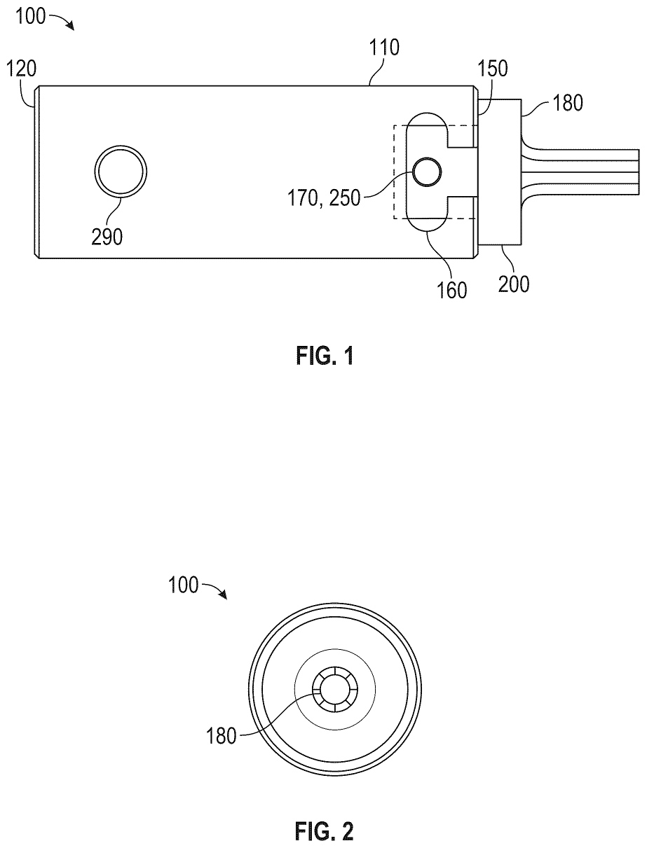

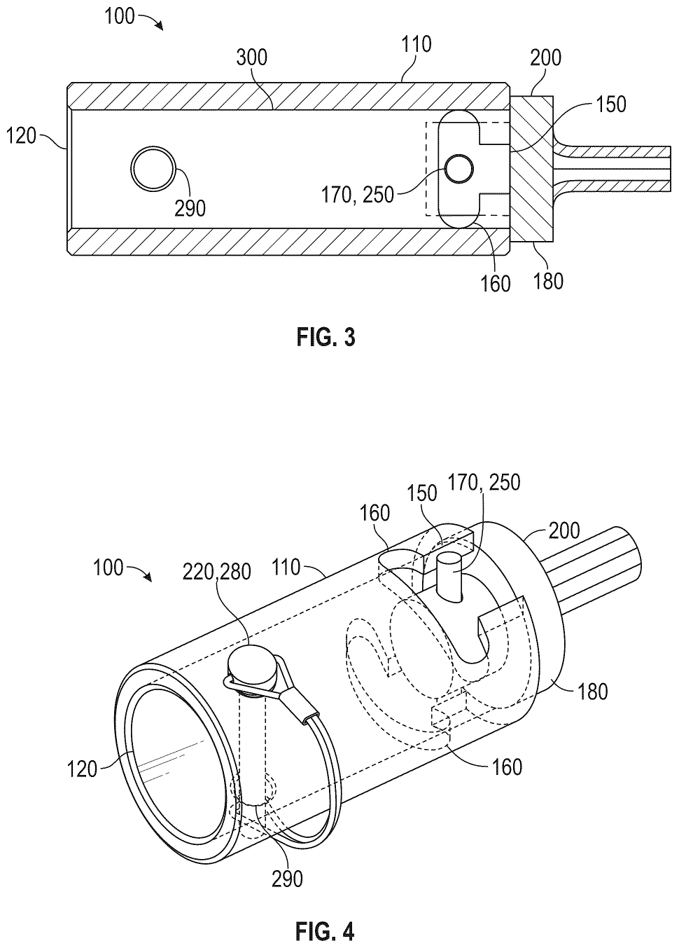

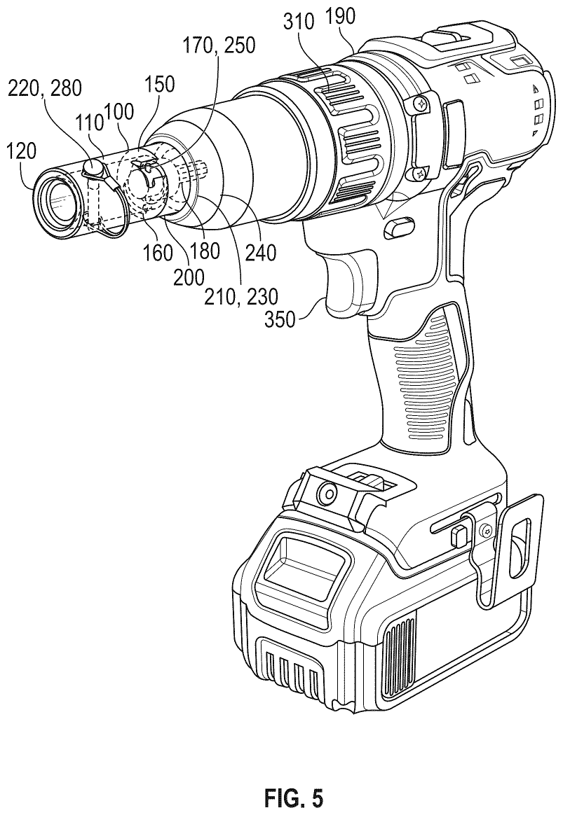

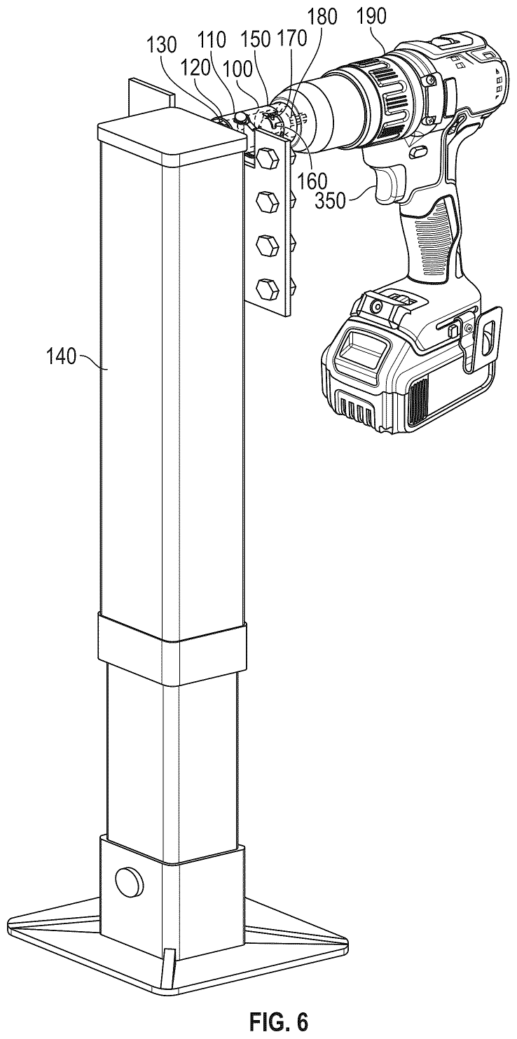

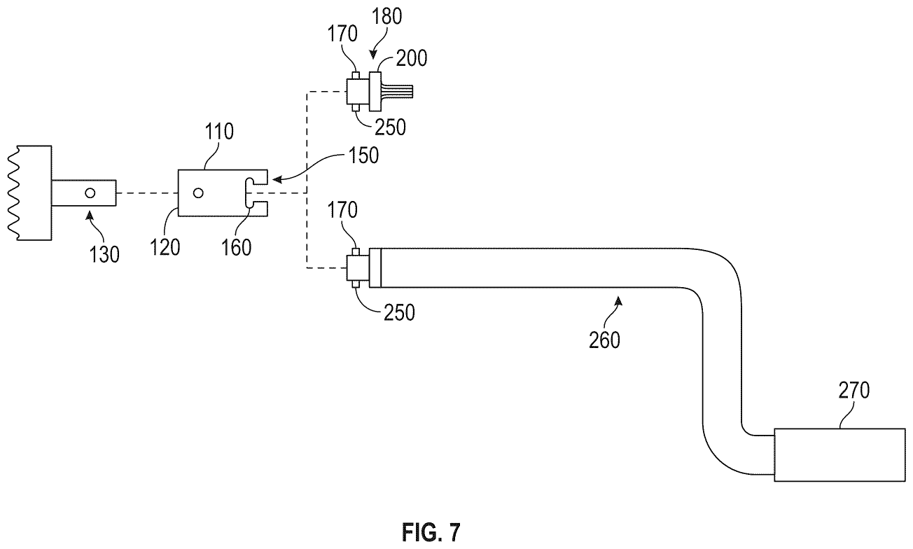

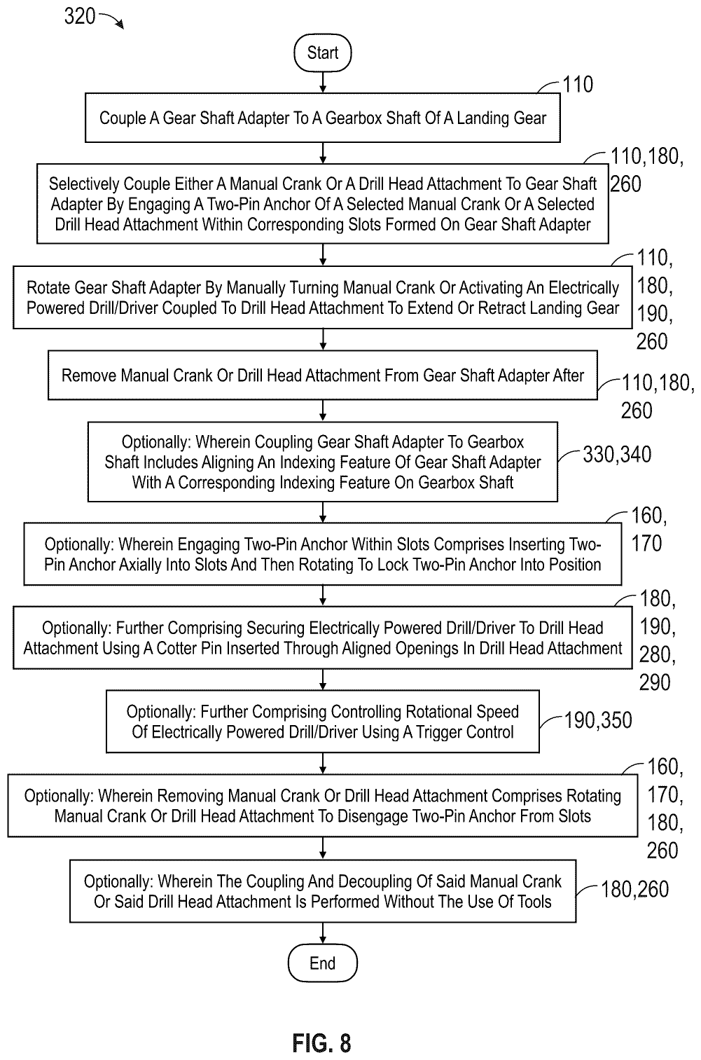

Referring to the Figures, there is shown in FIGS. 1, 2, 3, 4, 5, 6, 7, and 8 the following features:
Element 100 which is a landing gear automation device for extending and retracting landing gear on a trailer.
Element 110 which is a gear shaft adapter.
Element 120 which is a first coupling end.
Element 130 which is a gearbox shaft.
Element 140 which is a trailer landing gear.
Element 150 which is a second coupling end.
Element 160 which is a slot.
Element 170 which is a two-pin anchor.
Element 180 which is a drill head attachment.
Element 190 which is an electrically powered drill/driver.
Element 200 which is a cylindrical collar.
Element 210 which is an open end of the cylindrical collar.
Element 220 which is a securing mechanism.
Element 230 which is an aperture.
Element 240 which is a fastener.
Element 250 which is a pin.
Element 260 which is a manual crank.
Element 270 which is an ergonomic handle.
Element 280 which is a cotter pin.
Element 290 which is an aligned opening.
Element 300 which is a sidewall.
Element 310 which is an alignment indicator.
Element 320 which is a method of operating a landing gear on a trailer.
Element 330 which is an indexing feature.
Element 340 which is a corresponding indexing feature.
Element 350 which is a trigger control.

The following detailed description provides instructions and details necessary for making and using the Dual-Mode Landing Gear Adapter with Interchangeable Manual and Powered Drive. The invention includes three main components: a gear shaft adapter device, and a drill head attachment for coupling to a portable electric drill/driver. Each component should be fabricated using standard machining techniques and common metalworking tools or manufacturing methods suitable for producing strong, durable metal components capable of transmitting rotational torque.

Gear Shaft Adapter: To manufacture the gear shaft adapter, begin by selecting a suitably strong and durable metal material, such as hardened steel alloy or aluminum alloy with high tensile strength, capable of withstanding repeated torque loads. Machining processes, such as CNC turning, milling, or precision casting, can be used to produce the adapter. The adapter comprises two coupling ends: the first coupling end and the second coupling end.

The first coupling end is machined to precisely engage with a standard gearbox shaft of a landing gear. This end should include a central bore or cavity shaped to match and securely fit onto the landing gear gearbox shaft. The first coupling end may include one or more apertures designed to accommodate locking pins or bolts for secure mechanical fastening, ensuring that the adapter will remain reliably engaged with the gearbox shaft under high torque conditions, in accordance with claim 4.

The second coupling end of the adapter should be machined with at least two axially oriented open-ended slots positioned opposite each other, sized and spaced to securely engage a two-pin anchor. The slots should allow easy axial insertion and rotation of the anchor to lock it securely into place, corresponding to claims 5, 6, and 16.

Manual Crank: To fabricate the manual crank, select a suitable metal material, such as stainless steel, steel alloy, or durable aluminum alloy. Machine a two-pin anchor with two metal pins arranged diametrically opposite each other, dimensioned to precisely fit the slots on the adapter's second coupling end as described in claim 5. At the opposite end of the crank, attach an ergonomically shaped handle made of a comfortable, durable material, such as molded polymer or rubber, improving grip and reducing user fatigue during manual operation, as specified in claim 8.

Drill Head Attachment: Manufacture the drill head attachment using a robust and durable metal, such as hardened steel or high-strength aluminum alloy. The attachment includes a cylindrical collar that is approximately 9.779 centimeters long, as set forth in claim 9, and has an internal diameter of at least 2.5 centimeters at the open end to ensure compatibility with standard drill/drivers, satisfying claim 10.

Drill precisely aligned apertures through the sidewall of the cylindrical collar, sized approximately between 0.635 centimeters and 1.27 centimeters in diameter, as claimed in claim 12. Insert a cotter pin or similar securing device through these apertures to reliably secure the drill/driver within the cylindrical collar during operation, as required by claim 11. To further enhance usability, apply clear alignment indicators or markings on the cylindrical collar to guide the correct positioning and attachment of the drill/driver, consistent with claim 13.

The drill head attachment also includes, at the end opposite the cylindrical collar, a two-pin anchor machined similarly to the manual crank, with diametrically positioned pins for secure coupling within the adapter's second coupling end slots.

Assembly and Installation: To use the device, first ensure the gear shaft adapter's first coupling end is correctly aligned with the gearbox shaft on the trailer landing gear. If present, align indexing features machined into both the adapter and the gearbox shaft to ensure proper orientation, as described in claim 15. Secure the adapter onto the gearbox shaft using fasteners through provided apertures or locking mechanisms as necessary, providing robust mechanical attachment, satisfying claim 4.

Next, choose between the manual crank and drill head attachment depending on operational requirements. To couple either device, insert the two-pin anchor of the selected attachment axially into the adapter's second coupling end slots. Rotate slightly to securely engage and lock the attachment into place, as specified by claims 5, 6, and 16.

Manual Operation: If manual operation is desired, rotate the manual crank handle in the appropriate direction to either extend or retract the landing gear legs, transferring torque securely through the engaged adapter to the gearbox shaft.

Powered Operation: For powered operation, insert a cordless, battery-operated electric drill/driver into the cylindrical collar of the drill head attachment, as outlined in claim 14. Align the drill chuck securely within the cylindrical collar, utilizing the provided alignment indicators for accuracy, complying with claim 13. Securely fasten the drill/driver in place using the cotter pin or similar securing mechanism through the collar's aligned apertures, per claims 11 and 17.

Activate the drill/driver by pressing its variable-speed trigger control, allowing precise control of torque and rotation speed applied to the landing gear shaft, as set forth in claim 18. This provides smooth, controlled extension or retraction of the trailer landing gear.

Removal of Attachments: Upon completion, deactivate the drill/driver or cease manual rotation. Rotate the crank or drill head attachment slightly in the opposite direction to release the two-pin anchor from the slots in the gear shaft adapter, facilitating quick, tool-free removal, as described in claims 16, 19, and 20. The attachments can be removed and interchanged swiftly as needed.

Operational Advantages: This dual-mode adapter device simplifies trailer landing gear operation by enabling rapid and secure interchangeability between powered and manual operational modes without additional tools. The robust construction, ergonomic design, and detailed alignment features improve operational efficiency and safety, reducing operator fatigue and increasing overall convenience and productivity.

Maintenance and Care: Regularly inspect all components for signs of wear or damage, particularly checking for deformation or excessive wear of coupling slots and pins. Clean components regularly to prevent dirt or debris from interfering with secure engagement. Lubricate metal surfaces periodically with appropriate lubricants to maintain smooth attachment, removal, and operation.

The present invention, when properly constructed and used as described herein, provides a significant advancement in the operational efficiency and convenience of trailer landing gear systems, effectively overcoming the shortcomings and limitations of previously existing devices.

In a preferred embodiment of the present invention there is a landing gear automation device configured for extending and retracting landing gear on a trailer, comprising a gear shaft adapter having a first coupling end structured to securely engage a gearbox shaft of the trailer landing gear, and an opposing second coupling end comprising at least two slots arranged to selectively engage a two-pin anchor; and a drill head attachment structured for operative coupling with an electrically powered drill/driver, the drill head attachment comprising a two-pin anchor arranged to selectively engage the slots of the gear shaft adapter. And, optionally a manual crank having a two-pin anchor structured to selectively engage the slots of the gear shaft adapter.

In an alternate embodiment of the present invention there is a gear shaft adapter wherein the first coupling end further comprises at least one aperture arranged for receiving a fastener, the fastener structured to secure the gear shaft adapter to the gearbox shaft, enhancing the secure mechanical connection.

In an alternate embodiment of the present invention there is a two-pin anchor comprising two pins positioned diametrically opposite each other, structured to securely engage the slots in the gear shaft adapter to ensure balanced torque transfer and reliable operation.

In an alternate embodiment of the present invention there is a second coupling end of the gear shaft adapter wherein the slots extend axially and are open-ended, structured to facilitate quick and convenient insertion and removal of the two-pin anchor, simplifying operational steps and reducing downtime.

In an alternate embodiment of the present invention there is a gear shaft adapter formed from a hardened metal alloy material, structured to withstand repeated high-torque loading without deformation or excessive wear, providing enhanced durability and service life.

In an alternate embodiment of the present invention there is a manual crank comprising an ergonomic handle opposite the two-pin anchor, structured to improve operator comfort and control during manual operation of the landing gear.

In an alternate embodiment of the present invention there is a drill head attachment comprising a cylindrical collar approximately 9.779 centimeters in length, structured to securely receive and couple with standard electrically powered drill/drivers, ensuring compatibility and secure attachment.

In an alternate embodiment of the present invention there is a cylindrical collar with an internal diameter of at least 2.5 centimeters at the open end, structured to accommodate commonly available drill/drivers, enhancing usability and flexibility.

In an alternate embodiment of the present invention there is a securing mechanism comprising a cotter pin extending through aligned openings formed through a sidewall of the cylindrical collar, structured to securely retain the drill/driver within the collar during operation, enhancing safety and reliability.

In an alternate embodiment of the present invention there are aligned openings having a diameter of between 0.635 centimeters and 1.27 centimeters, structured to optimally accommodate a cotter pin for reliable and tool-free securement of the drill/driver.

In an alternate embodiment of the present invention there is a cylindrical collar further comprising alignment indicators, structured to assist the operator in properly aligning and coupling the drill/driver, thereby facilitating accurate and secure engagement.

In an alternate embodiment of the present invention there is an electrically powered drill/driver that is cordless and battery-operated, structured to improve convenience, mobility, and ease of use, especially in environments where external power sources are unavailable.

In a preferred embodiment of the present invention there is a drill head attachment further comprising a cylindrical collar having an open end structured for securely receiving and coupling with an electrically powered drill/driver, and a securing mechanism extending through the cylindrical collar structured to secure the drill/driver in operative engagement with the cylindrical collar.

In an alternate embodiment of the present invention there is a cylindrical collar having alignment indicators structured to ensure proper positioning and secure coupling of the drill/driver within the cylindrical collar, reducing the risk of improper attachment and operation.

In a preferred embodiment of the present invention there is a method for operating landing gear on a trailer comprising coupling a gear shaft adapter to a gearbox shaft of the landing gear, selectively coupling either a manual crank or a drill head attachment to the gear shaft adapter by engaging a two-pin anchor within corresponding slots formed on the gear shaft adapter, rotating the gear shaft adapter by manually turning the crank or activating an electrically powered drill/driver coupled to the drill head attachment to extend or retract the landing gear, and removing the crank or drill head attachment from the gear shaft adapter after operation.

In an alternate embodiment of the present invention there is a method wherein coupling the gear shaft adapter includes aligning an indexing feature of the adapter with a corresponding indexing feature on the gearbox shaft, structured to ensure correct rotational alignment for efficient torque transfer.

In an alternate embodiment of the present invention there is a method wherein engaging the two-pin anchor within the slots comprises inserting the two-pin anchor axially into the slots and rotating it to securely lock it into position, providing secure and stable coupling during operation.

In an alternate embodiment of the present invention there is a method further comprising securing the drill/driver to the drill head attachment using a cotter pin inserted through aligned openings in the drill head attachment, structured to reliably retain the drill/driver during powered operation.

In an alternate embodiment of the present invention there is a method further comprising controlling rotational speed of the drill/driver using a variable-speed trigger control, structured to allow precise and safe operation of the landing gear extension and retraction process.

In an alternate embodiment of the present invention there is a method wherein removing the crank or drill head attachment comprises rotating the attachment to disengage the two-pin anchor from the slots, structured to enable quick and easy removal of attachments without additional tools.

In an alternate embodiment of the present invention there is a method wherein coupling and decoupling of the crank or drill head attachment is performed without additional tools, structured to provide enhanced convenience and reduced operational downtime, thus significantly improving the efficiency of landing gear operation.

In an optional configuration of the present invention, the gear shaft adapter can be fabricated from various alternative materials, including lightweight aluminum alloys, titanium alloys, or reinforced composite materials, depending upon the specific load requirements, durability expectations, and cost considerations for particular applications or operating environments. Such material alternatives allow for tailored solutions, offering benefits such as weight reduction, corrosion resistance, or cost savings.

Alternatively, the two-pin anchor arrangement can be replaced with multi-pin or spline arrangements, providing an increased number of torque-transmitting points. These alternatives could enhance the adapter's ability to withstand higher torque loads and provide smoother torque transmission, particularly beneficial in heavy-duty commercial or industrial trailer applications.

Optionally, the cylindrical collar on the drill head attachment can include internal gripping surfaces, such as knurling, ridges, or friction-enhancing coatings, to improve the securement and prevent slippage of the drill chuck during high-torque operations. These internal enhancements further assure stability and improve safety during prolonged use.

Another alternative includes providing a quick-release locking mechanism integrated into the adapter itself, allowing the operator to engage and disengage attachments rapidly with a single motion, such as a spring-loaded collar or quick-lock coupler. This option would enhance operational convenience and significantly decrease the time required to transition between manual and powered operation modes.

In an alternate embodiment, the ergonomic handle on the manual crank can be constructed from various shock-absorbing materials, including rubberized polymers, silicone composites, or gel-filled grips, reducing vibration transfer to the operator's hands and improving comfort during extended manual use.

Optionally, the cylindrical collar may be provided with additional external reinforcement bands or sleeves made from durable polymers or metallic materials to further increase structural integrity and resist deformation under prolonged use or harsh environmental conditions.

An additional option involves incorporating a protective surface coating or plating, such as zinc, nickel, chrome plating, powder coating, or anodizing, applied to metal surfaces of the adapter, crank, and drill attachment. Such coatings can significantly enhance corrosion resistance, improve wear characteristics, and provide aesthetic improvements.

Optionally, the cylindrical collar may also incorporate adjustable internal spacers or sleeves, allowing it to securely accommodate drill/drivers of varying sizes or shapes, providing even greater flexibility and compatibility with a broader range of standard commercial power tools.

Another possible feature is embedding torque-limiting or torque-monitoring devices into the drill head attachment, providing feedback or automatic torque control during operation. This could prevent overloading of the landing gear or drill/driver and enhance operational safety and reliability.

In yet another alternative, the adapter and attachments can be designed with modular replaceable parts, allowing users to quickly swap out worn or damaged components without replacing the entire apparatus. This modularity greatly simplifies maintenance, reduces costs, and extends the service life of the invention.

The present invention provides numerous advantages over existing trailer landing gear operation methods and devices. First and foremost, the invention delivers a significant enhancement in user convenience by enabling rapid interchangeability between manual and powered operational modes. Operators can quickly and effortlessly transition between using a traditional manual crank and a powered drill attachment without specialized tools, thereby saving valuable operational time.

Additionally, the present invention significantly improves safety by providing a robust and secure connection between the landing gear gearbox shaft and both manual and powered drive devices. The precision-machined two-pin anchor and corresponding slots in the adapter ensure stable torque transfer and minimize risks associated with attachment slippage or unintended disengagement, even during prolonged or high-torque operations.

Another substantial advantage of the present invention is its compatibility with widely available and commonly used cordless or corded electric drills/drivers. Unlike existing powered landing gear systems, which often require expensive and complex permanent installations, the invention utilizes standard, commercially available tools, significantly reducing initial investment and long-term maintenance costs.

The ergonomic features of the invention, such as the inclusion of an ergonomically shaped manual crank handle, provide operators with enhanced comfort and reduced fatigue during manual landing gear operation. This feature is particularly beneficial in situations where power tools are unavailable or when manual operation is preferred.

Furthermore, the detailed structural specifications, such as the precisely dimensioned cylindrical collar, alignment indicators, and securing mechanisms, provide a consistently secure and stable operational experience. These precise structural features reduce operator error, enhance ease of use, and ensure reliable, repeatable performance under varied conditions and repeated usage cycles.

The invention's robust design and choice of durable, high-quality materials, such as hardened steel alloys or reinforced aluminum alloys, significantly extend the service life of components. The invention is engineered to withstand repeated, heavy-duty use in demanding transportation, logistics, and industrial environments without excessive wear or structural compromise.

Another important advantage of the invention is its inherent flexibility and adaptability. The ability to utilize either manual or powered operational modes allows users to maintain operational capabilities even in remote or field conditions where power tool batteries may be depleted or unavailable, ensuring uninterrupted usability under diverse circumstances.

Finally, the invention's modular design options and adaptability to alternative features or enhancements, such as torque-monitoring devices, quick-release mechanisms, and replaceable modular parts, provide further improvements in operational efficiency, ease of maintenance, reduced downtime, and overall economic value. These expanded possibilities demonstrate the invention's broad applicability and versatility, making it highly suitable for a wide range of trailer landing gear applications.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A landing gear automation device for extending and retracting landing gear on a trailer, comprising:
a gear shaft adapter comprising:
a first coupling end configured to securely engage a gearbox shaft of a trailer landing gear;
a second coupling end opposite said first coupling end, comprising at least two slots configured to selectively engage a two-pin anchor; and
a drill head attachment configured to couple with an electrically powered drill/driver, said drill head attachment comprising said two-pin anchor configured to be selectively received in said at least two slots of said second coupling end.

2. The landing gear automation device of claim 1, wherein said drill head attachment further comprises:
a cylindrical collar having an open end configured for securely receiving and coupling with said electrically powered drill/driver; and
a securing mechanism extending through said cylindrical collar, configured to secure said electrically powered drill/driver in operative engagement with said cylindrical collar.

3. A method of operating a landing gear on a trailer, comprising:
coupling a gear shaft adapter to a gearbox shaft of said landing gear;
selectively coupling either a manual crank or a drill head attachment to said gear shaft adapter by engaging a two-pin anchor of a selected manual crank or a selected drill head attachment within corresponding slots formed on said gear shaft adapter;
rotating said gear shaft adapter by manually turning said manual crank or activating an electrically powered drill/driver coupled to said drill head attachment to extend or retract said landing gear; and
removing said manual crank or said drill head attachment from said gear shaft adapter after.

4. The landing gear automation device of claim 1, wherein said first coupling end includes at least one aperture configured for receiving a fastener to secure said gear shaft adapter to said gearbox shaft.

5. The landing gear automation device of claim 1, wherein said two-pin anchor comprises two pins positioned diametrically opposite one another.

6. The landing gear automation device of claim 1, wherein said slots of said second coupling end extend axially and are open-ended to facilitate insertion and removal of said two-pin anchor.

7. The landing gear automation device of claim 1, wherein said gear shaft adapter is constructed from a hardened metal alloy.

8. The landing gear automation device of claim 1, further comprising a manual crank, wherein said manual crank comprises an ergonomic handle opposite said two-pin anchor.

9. The landing gear automation device of claim 2, wherein said cylindrical collar has a length of approximately 9.779 centimeters.

10. The landing gear automation device of claim 2, wherein said cylindrical collar has an internal diameter of at least 2.5 centimeters at said open end.

11. The landing gear automation device of claim 2, wherein said securing mechanism comprises a cotter pin extending through aligned openings formed through a sidewall of said cylindrical collar.

12. The landing gear automation device of claim 11, wherein said aligned openings have a diameter of between 0.635 centimeters and 1.27 centimeters.

13. The landing gear automation device of claim 2, wherein said cylindrical collar further comprises alignment indicators to ensure proper coupling with said electrically powered drill/driver.

14. The landing gear automation device of claim 1, wherein said electrically powered drill/driver is cordless and battery-operated.

15. The method of claim 3, wherein coupling said gear shaft adapter to said gearbox shaft includes aligning an indexing feature of said gear shaft adapter with a corresponding indexing feature on said gearbox shaft.

16. The method of claim 3, wherein engaging said two-pin anchor within said slots comprises inserting said two-pin anchor axially into said slots and then rotating to lock said two-pin anchor into position.

17. The method of claim 3, further comprising securing said electrically powered drill/driver to said drill head attachment using a cotter pin inserted through aligned openings in said drill head attachment.

18. The method of claim 3, further comprising controlling rotational speed of said electrically powered drill/driver using a trigger control.

19. The method of claim 3, wherein removing said manual crank or said drill head attachment comprises rotating said manual crank or said drill head attachment to disengage said two-pin anchor from said slots.

20. The method of claim 3, wherein a coupling and a decoupling of said manual crank or said drill head attachment is performed without the use of tools.
